(19) United States
(12) Patent Application Publication
(10) Pub. No.: US 2019/0187373 A1
(43) Pub. Date: Jun. 20, 2019

(54) HYBRID FIBER INTEGRATED SOI/III-V MODULE

(71) Applicant: Roshmere, Inc., San Diego, CA (US)

(72) Inventors: Ivan Shubin, San Diego, CA (US); Stevan S. Djordjevic, San Diego, CA (US); Ping-Piu Kuo, San Diego, CA (US)

(73) Assignee: Roshmere, Inc., San Diego, CA (US)

(21) Appl. No.: 16/218,451

(22) Filed: Dec. 12, 2018

Related U.S. Application Data
(60) Provisional application No. 62/607,193, filed on Dec. 18, 2017.

(51) Int. Cl. G02B 6/122; G02B 6/30; G02B 6/42

(52) U.S. Cl. CPC G02B 6/1225; G02B 2006/12121; G02B 6/4228; G02B 6/305

(57) ABSTRACT

In some embodiments, an integrated photonic module contains, a silicon-on-insulator platform, an integrated photonic component, and an optical fiber. The silicon-on-insulator platform can contain a silicon-on-insulator photonic circuit, a co-fabricated spot size converter, and a co-fabricated micromachined trench structure. The co-fabricated micromachined trench structure can contain dimensions compatible with the optical fiber, and the optical fiber can be bonded to, and disposed at least partially within, the micromachined trench structure. The optical modes of the optical fiber, the integrated photonic component, the co-fabricated spot size converter, and the silicon-on-insulator photonic circuit can also be spatially aligned with one another.

### RELATED APPLICATIONS

The application claims the benefit of U.S. Provisional Patent Application No. 62/607,193 filed on Dec. 18, 2017, and entitled “HYBRID FIBER INTEGRATED SOT/III-V MODULE;” which is hereby incorporated by reference for all purposes.

### BACKGROUND

Silicon-on-insulator (SOI) based photonic circuits have been a powerful engineering tool enabling sophisticated high-performance communication solutions. They have proven to be high volume manufacturable on a CMOS compatible platform. A wide range of devices and structures have been successfully designed and implemented, both passive and active, with the exception of the SOT/CMOS compatible light sources. Therefore, SOI based photonic circuits often use external light sources that are not directly integrated onto the SOI platform for the input/output optical signal delivery.

External light sources have been coupled with SOI based photonic circuits using discrete components that are actively aligned with one another to create a module. In some cases, SOI based photonic circuits and other discrete optical components are mounted on an interposer, with all of the components aligned, to create a module. For example, SOI based photonic circuits, optical waveguides, lenses or other separately fabricated spot size converters, and photonic chips (e.g., lasers) have been mounted on an interposer to form a module. Modules that are fabricated from separate components are typically expensive to produce, and typically suffer from reliability problems due in part to the connection of the different components within the module.

In some cases, optical fibers can be coupled to the module using either active or passive alignment. In other cases, light can be coupled into the module using grating couplers, which can be co-fabricated with the SOI photonic circuits.

### SUMMARY

In some embodiments, an integrated photonic module comprises, a silicon-on-insulator platform, an integrated photonic component, and an optical fiber. The silicon-on-insulator platform can comprise a silicon-on-insulator photonic circuit, a first set of metal contact pads, a co-fabricated spot size converter, and a co-fabricated micromachined trench structure. The integrated photonic component can comprise a second set of metal contact pads, and the second set of metal contact pads can be connected to the first set of metal contact pads. Furthermore, the co-fabricated micromachined trench structure can comprise dimensions compatible with the optical fiber, and the optical fiber can be bonded to, and disposed at least partially within, the micromachined trench structure. The optical modes of the optical fiber, the integrated photonic component, the co-fabricated spot size converter, and the silicon-on-insulator photonic circuit can also be spatially aligned with one another.

In some embodiments, an integrated photonic module comprises, a silicon-on-insulator platform, and an optical fiber. The silicon-on-insulator platform can comprise a silicon-on-insulator photonic circuit, a co-fabricated spot size converter, and a co-fabricated micromachined trench structure. The co-fabricated micromachined trench structure can comprise dimensions compatible with the optical fiber, and the optical fiber can be bonded to, and disposed at least partially within, the micromachined trench structure. The optical modes of the optical fiber, the integrated photonic component, the co-fabricated spot size converter, and the silicon-on-insulator photonic circuit can also be spatially aligned with one another.

### BRIEF DESCRIPTION OF THE DRAWINGS

FIGS. 1A-1D are simplified schematic diagrams of portions of integrated photonic modules, in accordance with some embodiments.

FIG. 2 is a simplified schematic diagram in three views of a silicon-on-insulator (SOI) platform for an integrated photonic module, in accordance with some embodiments.

FIG. 3A is a simplified schematic diagram of an integrated photonic component for an integrated photonic module, in accordance with some embodiments.

FIG. 3B is a simplified schematic diagram in three views of portions of an integrated photonic module containing an integrated photonic component and an SOI platform, in accordance with some embodiments.

FIG. 4 is a simplified schematic diagram in three views of portions of an integrated photonic module containing an integrated photonic component and an SOI platform, in accordance with some embodiments.

FIG. 5 is a simplified schematic diagram in three views of an integrated photonic module containing optical fibers, an integrated photonic component, and an SOI platform, in accordance with some embodiments.

### DETAILED DESCRIPTION

The current disclosure describes an integrated photonic module containing an SOI photonic circuit with an intimately optically coupled integrated photonic component. For example, the integrated photonic component can be a laser containing a III-V material (or a light emitting diode, or a photodetector, or a modulator, etc.), and can be flip-chip bonded to an SOI platform containing an SOI photonic circuit. In some embodiments, this results in an integrated photonic module capable of on-chip data-processing (e.g., using a high-quality laser to transmit data on-chip). In other embodiments, the integrated photonic modules described herein serve as external multiple wavelength sources for electro-optic systems. The disclosed concepts enable a low-cost high-accuracy module including input/output optical signal delivery for integrated SOI photonic circuits. In some embodiments, the structures described are connected to one or more optical fibers to enable optical signal input/output, or optical seeding for the III-V material. Due to the combined integrated configuration of the SOI photonic circuit, the integrated photonic component, and the connected optical fiber, these modules can achieve improved performance and reliability compared to conventional devices. In different embodiments, the modules described herein can be used in photonic systems for communication (e.g., long-haul, metro, short reach, radio-over-fiber, etc.), optical sensing systems, optical processing systems, or any system employing hybrid opto-electric on-chip communication (e.g., optical buses).

Optical gain chips are some examples of integrated photonic components that can be used in the integrated photonic modules described herein. Some examples of optical gain chips are light sources such as lasers or LEDs, and optical amplifiers such as semiconductor optical amplifiers (SOAs). Other examples of integrated photonic components are tunable filters. In some embodiments, the integrated photonic components are based on III-V materials, SiN materials, SiGe-based materials, or other appropriate materials. Additionally, it is understood that when the disclosure herein describes one of these types of materials, any of the other materials may be substituted therefor, unless specifically stated otherwise in the disclosure or the claims. The integrated photonic component can be a source of coherent light for the SOI photonic circuitry if the integrated photonic component contains an edge-emitting laser (EEL). In some embodiments, the integrated photonic component contains an integrated array of EELs, each producing a different wavelength. In some embodiments, the integrated photonic component can operate at any appropriate communication wavelength, e.g., 1100-1600 nm, etc. In some embodiments, the integrated photonic components can be single or arrayed InP based light sources (e.g., edge emitting lasers (EELs)). In some embodiments, the integrated photonic component contains a gain chip, which can contain III-V materials, and operate at any appropriate communication wavelength, e.g., 1100-1600 nm, etc. In some embodiments, the integrated photonic component contains a semiconductor optical amplifier (SOA), which can contain III-V materials, and operate at any appropriate communication wavelength, e.g., 1100-1600 nm, etc. The integrated photonic module (e.g., a light source) can include multiple wavelengths for wavelength division multiplexing (WDM) applications in some embodiments. In some embodiments, the integrated photonic component can be a SiN based tunable optical filter.

In some embodiments, the SOI platform for producing the module contains SOI photonic circuitry, a spot size converter (SSC), and a micromachined input/output fiber optic coupler. SSCs can contain an optical input and an optical output, and the spot size of light input to the SSC will be different from the spot size of the light output from the SSC. In some embodiments, the SSC and micromachined input/output fiber optic coupler are formed from the same SOI platform containing the SOI photonic circuitry (i.e., are co-fabricated with the SOI photonic circuitry).

In embodiments where the integrated photonic module is connected to an optical fiber, the optical fiber may have a diameter from 50 microns to 500 microns, or about 62.5 microns, or about 125 microns, or about 250 microns. In some embodiments, the optical fibers are single mode (SM) fibers. In some embodiments, the fibers have optical mode diameters from about 3 microns to about 12 microns.

The micromachined input/output fiber optic coupler of the integrated photonic module generally includes a highly accurately micromachined trench, groove structure, recess, receptacle, or other appropriate mating structure for an optical fiber. In some embodiments, the micromachined trench structure has a generally V-shaped groove geometry in cross section, e.g., a V-groove geometry with a flat bottom (for an overall trapezoidal shape), or a V-groove geometry with a pointed bottom (for an overall triangular shape). In some embodiments, other cross section geometries may be used, such as stepped, rectangular, circular, ellipsoid, and curved. The micro-machined trenches with such cross-sectional geometries can be formed using accordingly compatible fabrication processes, for example dry or wet etching techniques with appropriately adjusted etch plane selectivities. The micromachined trench structure is generally sized and shaped to accommodate an appropriately sized and shaped optical fiber. The micromachined trench structure may thus be sized and shaped with dimensions that correspond to the dimensions of the optical fiber for the optical fiber to fit at least partially, or fully, within the micromachined trench structure. In different embodiments, and depending on how the optical fiber fits within the micromachined trench structure, the width of the optical fiber may be greater than, less than, or equal to the maximum width of the micromachined trench structure.

In some embodiments, the co-fabricated SSCs of the integrated photonic module can include SOI waveguides. The SSC can transition the relatively large optical mode of the fiber (e.g., a 3-12 micron spot size) into a smaller submicron SOI waveguide mode with negligible loss. In some embodiments, the SSC contains a waveguiding layer made in material (e.g., silicon, or silicon nitride) with sufficiently high optical refractive index (e.g., greater than 1.6, or greater than 2.0, or greater than 2.5, or greater than 3.0, or greater than 3.5, or from 2.0 to 4.0). In some cases, the waveguiding material is patterned to have a lengthwise varied shape (e.g., tapered, photonic bandgap structure, or other shape) that allows for an adiabatic change in optical mode size. In some cases, the patterned waveguide is sandwiched between materials (e.g., silicon oxide, glass, or TEOS for example) with lower optical refraction indices (e.g., less than 1.6, or less than 2.0, or less than 1.5, or from 1.0 to 2.0). The co-fabricated SSCs described herein have several advantages over conventional methods of coupling light into an SOI based photonic circuit. Compared to conventional coupling using individual components (e.g., SSCs, lenses, etc.) that are connected to a separately fabricated SOI photonic circuit, the co-fabricated SSCs described herein enable improved positional accuracy with passive alignment, lower insertion loss, and reduced fabrication costs. The improvement in passive alignment accuracy can be enabled by co-fabricating the SSC with its alignment micro-machined trench. For example, co-fabrication can be performed in a foundry with highly accurate lithographic tooling yielding sub-micron feature to feature registration or, in this case, V-groove to SSC registration and, as a result, sub-micron optical fiber to SSC passive alignment. Compared to conventional SOI photonic circuits using co-fabricated grating couplers (GCs), the co-fabricated SSCs described herein enable lower insertion loss, wider acceptable wavelength range, and reduced sensitivity to process variations. Relative to SSC, the GCs suffer from relatively narrow wavelength bandwidth of, for example, ˜25-35 nm (3dB passband) versus greater than 100 nm for SSCs, several dB (2-4 dB) higher coupling loss, and large variability of the peak wavelength (+/−5 nm) across the wafer or wafer-to-wafer. Such performance substantially limits the GCs performance and attractiveness for fiber optic applications, dense WDM (DWDM) in particular.

In some embodiments, an array of optical fibers is inserted into an array of micromachined trench structures of an integrated photonic module. Due to the micromachined trench structures the fibers are aligned relative to the SOI SSCs, and the co-fabricated SSCs are aligned relative to the SOI photonic circuit. The resulting integrated photonic module provides low loss optical coupling between the input fiber and the SOI photonic circuit.

In some embodiments, the SSC, fiber optic couplers, and photonic circuits are formed from the same SOI substrate (e.g., are co-fabricated using lithographic microfabrication techniques). One advantage of this fabrication technique is that these components will be very well aligned with one another. In some embodiments, the SOI SSCs and V-grooves are co-fabricated, and therefore accurately registered and aligned to each other. This technique contrasts with conventional fabrication techniques, where a finished SOI based photonic circuit (including a thick, e.g., 20 micron, dielectric protective top layer) is subsequently attached to other separately fabricated optical components (e.g., light sources, lenses and/or optical fibers). Such conventional approaches suffer from inferior alignment accuracies and/or fabrication tolerances compared to the disclosed integrated modules because they rely on active alignment, whereas the disclosed approach utilizes passive alignment and facilitated assembly. For example, in some of the conventional approaches, the thick dielectric needs to be selectively removed, and then the other optical components actively aligned to the SOI based circuitry when attached thereto. Thus, an advantage of the disclosed integrated module approach is that it achieves greater alignment accuracy or tolerances without increased cost. Additionally, in order to achieve sub-micron alignment accuracy, if even possible at all, conventional techniques require complex fabrication techniques, so another advantage of the disclosed integrated module approach is that the fabrication cost is lower than conventional techniques for the same degree of alignment accuracy.

Different components can be used to create the integrated modules described herein. For example, parts of the SOI platform can include multiple back-end dielectrics and metals (or dielectric and metal layers) with integrated on-chip VLSI electronics. Such components have been manufactured with high yield on SOI wafers and in high volume. The integrated photonic components can be custom designs to interface with the SOI platform, or be standard components. Furthermore, processes exist to integrate some of the different components of the described modules, and the process changes required for the disclosed module to be assembled are none or minimal.

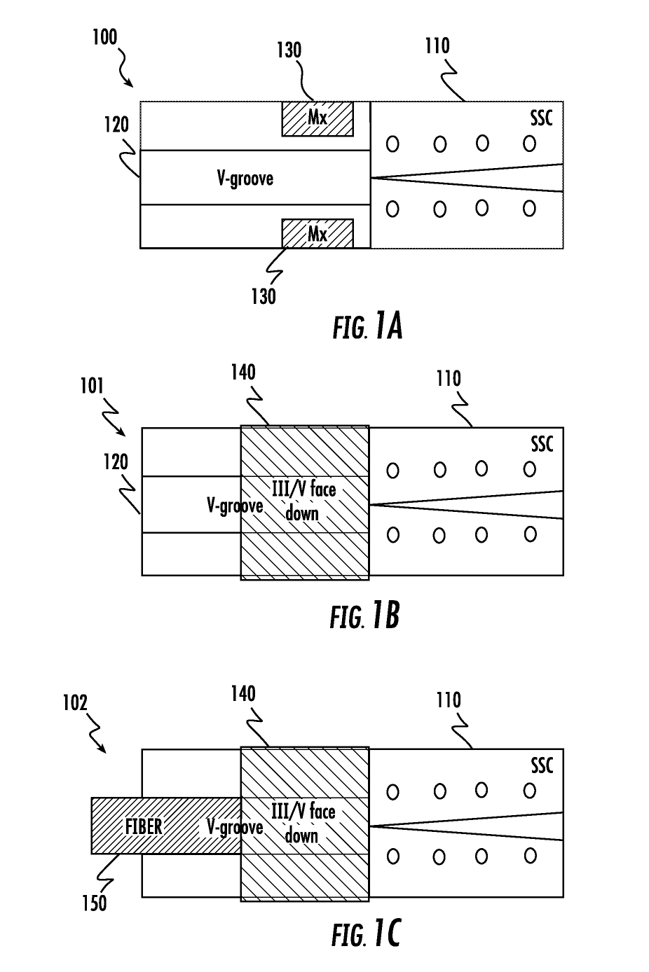

FIGS. 1A-1D show some non-limiting examples of components of the modules described herein. FIG. 1A shows the SOI platform 100 containing the SSC 110, the micromachined trench structure (e.g., a micromachined input/output fiber optic coupler structure, or a micromachined “V-groove” structure) 120, and metal contact pads (“Mx”) 130. The SSC 110 is located between the micromachined structure 120 and the SOI photonic circuitry (not shown). The SOI platform 100 containing the SSC 110, the micromachined trench structure 120, metal contact pads 130, and the SOI photonic circuitry (not shown) are co-fabricated and, therefore, accurately aligned and registered to one another.

FIG. 1B shows a module 101 containing the integrated photonic component 140 as described above (e.g., oriented face down), which is electrically connected to the metal pads 130 of the platform 100. FIG. 1C shows a module 102 containing the optical fiber 150, bonded to the micromachined structure 120 (which is obscured in FIG. 1C), such that the optical fiber 150, integrated photonic component 140, and SSC 110 are accurately aligned and registered to one another. The micromachined structure 120 enables passive alignment of the fiber to the SSC 110, which is aligned with the SOI photonic circuit (not shown). The module 102 shown in FIG. 1C, therefore, provides a complete solution for input/output optical signal delivery for integrated SOI photonic circuits.

In the example embodiments shown in FIGS. 1B and 1C, the integrated photonic component is connected to the SOI based platform, with the active device (e.g., a laser stack) of the integrated photonic component adjacent to the SOI based platform and the substrate of the integrated photonic component oriented away from the SOI based platform. In some embodiments, the active device layers in the integrated photonic component produce significant amounts of heat, so heat dissipation away from the integrated photonic component is important. Mounting the integrated photonic component with the active layers adjacent to the SOI based platform can be advantageous for heat dissipation. For example, the materials and structures within the SOI based platform (e.g., the metal contact pads) can be designed to effectively conduct heat away from the integrated photonic component.

FIG. 1D shows an SOI platform 103 containing two side-by-side optical inputs/outputs for the SOI photonic circuitry 170, each containing SSC 110, micromachined trench structure (e.g., a micromachined input/output fiber optic coupler structure, or a micromachined “V-groove” structure) 120, metal contact pads (“Mx”) 130, and optical waveguides 160. The optical waveguides 160 couple light from the SSC into the photonic circuit 170. Similar to the structures shown in FIGS. 1A-1C, the SSCs 110 are located between the micromachined structures 120 and the SOI photonic circuitry 170. The SOI platform 103 and the SOI photonic circuitry 170 can be co-fabricated, to enable accurate alignment and registration to one another. The photonic IC 170 can have different capabilities, for example, signal transmitting, signal receiving, signal modulation and/or signal demodulation, and tuning capabilities. In other embodiments, more than 2 inputs/outputs (e.g., greater than 10, greater than 20, greater than 50, or from 1 to 100 inputs/outputs) for the SOI photonic circuitry 170 are included in the platform 103, and the module.

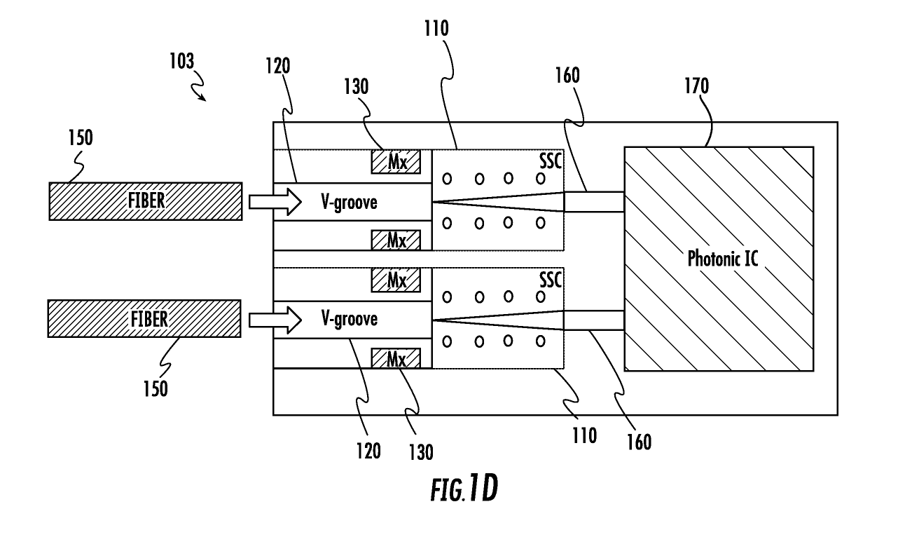

FIG. 2 shows a non-limiting example of the SOI based platform 100 for the modules described herein. Reference number 210 shows a top view of the SOI based platform. Reference number 220 shows a side cross section view of the SOI based platform. Reference number 230 shows an edge-on cross section view of the SOI based platform. Cross-section indicator 280 taken through the top view 210 shows the relative location of the side cross section view 220. Cross-section indicator 290 taken through the top view 210 shows the relative location of the edge-on cross section view 230. The cross-section indicators 280 and 290 include arrows which define the direction of viewing after the cross-section is taken. The platform shown in FIG. 2 has 2 side-by-side optical inputs/outputs for the SOI photonic circuitry. In other embodiments, more than 2 inputs/outputs (e.g., greater than 10, greater than 20, greater than 50, or from 1 to 100 inputs/outputs) for the SOI photonic circuitry are included in the platform and the module. Micromachined trench structures (e.g., V-grooves) 240, metal pads 250, and co-fabricated SSCs 260 are shown in the figure. The metal pads 250 can be part of the back end of the line (BEOL) stack-up and exposed in parallel with micromachined trench fabrication. The trenching requires removal of the BEOLs top dielectrics which can be accomplished with dry etching processes. Metal pads are to be built into the BEOL stack and are compatible with the III-V die layout and its set of metal pads to be soldered. The dry etching processes can be selective such that the dielectrics are removed while metal pads remain intact and become exposed and accessible for III-V integration. FIG. 2 shows that the metal pads 250 can be connected to the SOI photonic circuitry (not shown) using metal traces 270. In some embodiments, the SOI based photonic circuitry can contain control circuitry to control the integrated photonic component. In some cases, the SOI based photonic circuitry can contain microprocessors (e.g., CMOS) to control the integrated photonic component. For example, an active feedback loop can be created using SOI based photonic circuitry containing a photodetector and circuitry to apply bias to an integrated laser (i.e., integrated photonic component) based on the parameters of the detected light.

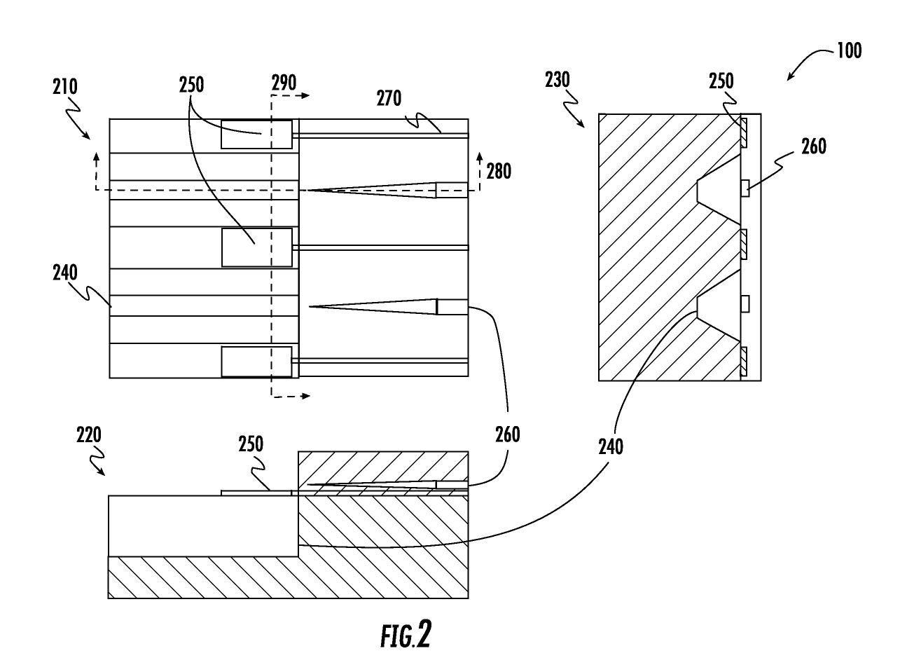

FIGS. 3A and 3B show a non-limiting example of an integrated photonic component 300 to be integrated with the SOI based platform 100 in the modules described herein. FIG. 3A shows the integrated photonic component 300, containing metal pads 310, and waveguides 320. For example, the integrated photonic component can be a laser, and the metal pads can be used to drive the laser. In other embodiments, the integrated photonic component 300 can be any type of integrated photonic component described above, and the metal pads 310 electrically connect the integrated photonic component to the SOI photonic circuitry.

FIG. 3B shows a non-limiting example of the SOI based platform 100 with the integrated photonic component 300 for the modules described herein. FIG. 3B includes a top view 330, a side cross section view 340, and an edge-on cross section view 350 of the integrated module, with similar cross-section locations as shown by the cross-section indicators 280 and 290 in FIG. 2, i.e., side cross section view 340 is taken along cross-section indicator 380, and edge-on cross section view 350 is taken along cross-section indicator 390. The integrated photonic component 300 is connected to the SOI based platform 100 by connecting the metal pads 310 of the integrated photonic component 300 to the metal pads 250 of the SOI based platform 100.

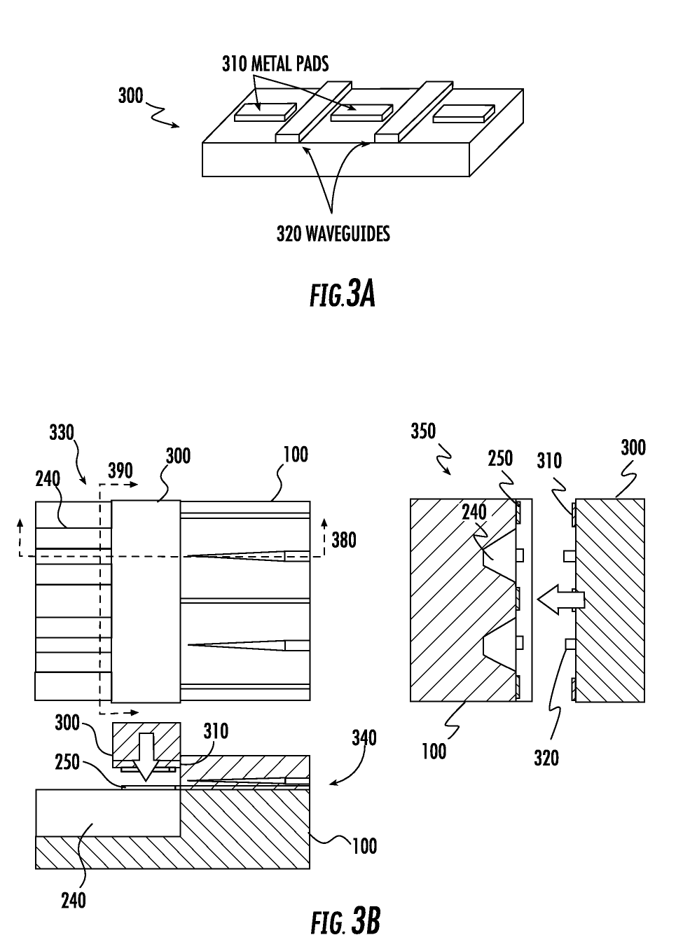

FIG. 4 shows non-limiting example of a module containing the integrated photonic component 300 connected to the SOI based platform 100. FIG. 4 includes a top view 420, a side cross section view 430, and an edge-on cross section view 440 of the integrated module, with similar cross-section locations as shown by the cross-section indicators 280 and 290 in FIG. 2, i.e., side cross section view 430 is taken along cross-section indicator 480, and edge-on cross section view 440 is taken along cross-section indicator 490.

FIG. 4 shows how, in some embodiments, the optical modes 410 of the integrated photonic component (e.g., the optical modes within the waveguides 320 in FIG. 3A) are aligned with the optical mode of the waveguides of the SSC 260, and have low optical loss between the integrated photonic component 300 and the co-fabricated SSC 260. In some embodiments, the interface of the integrated photonic component 300 and the interface of the SOI based platform 100 are appropriately configured and structured to match their topology and connect the two structures optically and electrically. For example, in some embodiments, the electrical contacts 310 are placed in close proximity to the III-V active region of the integrated photonic component 300. Additionally, in some cases, the size of the electrical contacts 310 are increased to reduce the thermal impedance of the structure to improve the thermal performance of the integrated photonic module 440. Once the integrated photonic component 300 as described above is inverted, aligned and attached to the interface of the SOI based platform 100 (flip-chip attached atop the micromachined trench structures 240 of the SOI based platform 100), their optical waveguides are aligned vertically by design. In some embodiments, the output/input optical modes sizes and locations of the integrated photonic component and SOI components (e.g., SSC and SOI photonic circuitry) are designed to enable low coupling losses between all components of the integrated photonic module.

Electrical interconnection can be established between the integrated photonic component 300 and the SOI based platform 100 with solder reflow or compression bonding of the metal pads 310 and 130 (or, 250). In some embodiments, solder is applied to either the integrated photonic component 300 or the SOI based platform 100 with appropriate under-bump metallization for the metal pads 310 and 130 (or, 250) for proper wetting and further reliability. In some embodiments, wafer-scale in-plane alignment between the integrated photonic component 300 and the SOI based platform 100 is carried out by high-precision flip-chip bonding techniques (e.g., passive, or vision based), or self-aligned solder reflow techniques (completely passive).

In some embodiments, the out-of-plane (or, vertical) alignment between the integrated photonic component 300 and the SOI based platform 100 uses etched mesas and stops. For example, the waveguides 320 of the integrated photonic component 300 can be mesa structures; and the metal pads 310 can be designed such that when they are connected to the metal pads 130 (or, 250) on the SOI based platform 100, the waveguides 320 of the integrated photonic component 300 are accurately aligned in the out-of-plane direction with the SSC 260 of the SOI based platform 100. In some embodiments, the metal pads 310 and 130 (or, 250) between the integrated photonic component 300 and the SOI based platform 100 are connected using solder, which introduces an uncontrolled out-of-plane dimension. In such cases, mesa structures (or opposing pairs of mesa structures) can be created in the integrated photonic component 300 (e.g., the waveguides 320 or alternate mesa structures) and/or the SOI based platform 100 (e.g., the bottom of the micromachined trench structures 240 or mesa structures formed thereon), which come into contact with one another when the integrated photonic component 300 is connected to the SOI based platform 100 and act as mechanical stops to accurately align the components in the out-of-plane direction.

In some embodiments, the module contains an external cavity laser (ECL) with the cavity extended into the SOI based photonic circuitry of the SOI based platform 100. In this configuration, the integrated photonic component 300 provides the optical gain and one mirror of the cavity, and the second mirror of the cavity is located within the SOI based photonic circuitry.

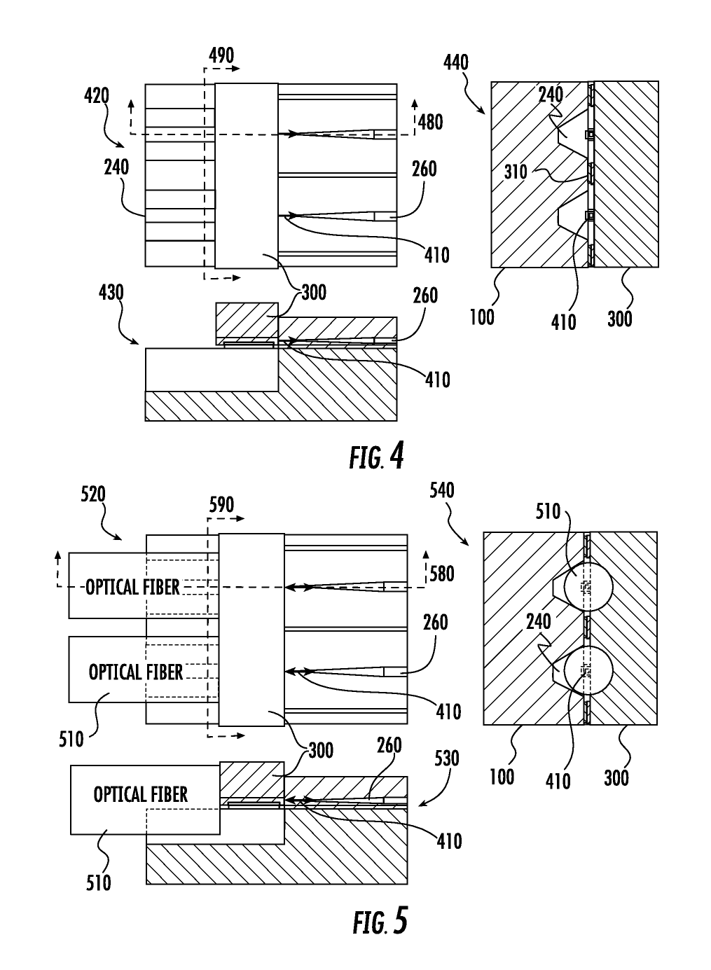

FIG. 5 shows a non-limiting example of a module containing the integrated photonic component 300 and optical fibers 510 connected to the SOI based platform 100. Reference number 520 shows a top view of the integrated module. Reference number 530 shows a side cross section view of the integrated module. Reference number 540 shows an edge-on cross section view of the integrated module. FIG. 5 uses similar cross-section locations as shown by the cross-section indicators 280 and 290 in FIG. 2, i.e., side cross section view 530 is taken along cross-section indicator 580, and edge-on cross section view 540 is taken along cross-section indicator 590.

The micromachined trench structures 240 can be used to align the optical fibers and butt-couple them into the waveguides 320 of the integrated photonic component 300. In some embodiments, a cover plate (i.e., a lid) is used to affix the optical fibers in place within the micromachined trench structures 240. In other embodiments, the optical fibers are affixed in place within the micromachined trench structures 240 using an adhesive (e.g., a UV curable adhesive) and a cover plate is not required. FIG. 5 shows that the optical modes 410 of the integrated photonic component 300 (e.g., the optical modes within the waveguides 320 in FIG. 3A) are aligned with the optical mode of the waveguides of the SSC 260 and the optical mode of the optical fibers 510, enabling a low optical loss path between the optical fibers 510, the integrated photonic component 300, and the SSC 260.

The optical fibers 510 and the integrated photonic component 300 as described above can be used to couple light into or out of the SSC 260 and the photonic circuitry. In some embodiments, the reflectivity of the integrated photonic component 300 (e.g., for embodiments having facets of a chip forming an SOA) can be configured such that the laser light from the integrated photonic component 300 can be output through the optical fiber 510 to the location of choice. In some embodiments, the photonic circuitry on the SOI based platform 100 can contain elements that select, stabilize and modulate the light signal exiting through the optical fiber 510. In some embodiments, an ECL can generate a single wavelength or multiple wavelengths (i.e., a comb) per exiting fiber.

The micromachined trench structures 240 on the SOI based platform 100 are designed to self-align the optical fibers 510 to the optical waveguides in the integrated photonic component 300 and/or SSC 260. One example micromachined structure that can accomplish the self-alignment are trenches or grooves, which mechanically direct the optical fibers 510 into the correct lateral and vertical position when each optical fiber 510 is pressed with a vertical force into the corresponding trench or groove. Once the optical fiber is pressed into place, an adhesive (e.g., UV-curable adhesive) can be used to hold the optical fiber in position. In some cases, an array of optical fibers can be seated into an array of grooves. In some embodiments of such cases, a lid can be assembled to a stripped-fiber end of a fiber stub, and the lid can be manipulated (e.g., with pick-and-place equipment) to press the array of fibers into the grooves. In other embodiments, adhesive is used to hold the fibers in place within the grooves and a lid is not needed. Other structures, such as ridges, can also be used to self-align the optical fibers 510 with the SOI based platform 100.

In some embodiments, light from an external light source can be coupled into the integrated photonic component using the optical fibers. For example, the fibers can seed light into a III-V EEL or a III-V-SOI ECL with external master signal, in order to control or optimize the spectral properties and stabilize the output of the integrated photonic component across the wide range of temperatures regardless of the on-chip thermal response or environment. In some embodiments, the integrated photonic component of the module is injection locked to an external oscillator source whose light is delivered to the integrated photonic component through the optical fibers. For example, the integrated photonic component can be a slave laser or oscillator, and a master laser (or oscillator) can be coupled to the integrated photonic component through the optical fibers integrated into the module. In some cases, the wavelength, phase and/or line width of the integrated photonic component can be injection locked to an external oscillator.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

1. An integrated photonic module, comprising:
a silicon-on-insulator platform comprising:
a silicon-on-insulator photonic circuit;
a first set of metal contact pads;
a co-fabricated spot size converter; and
a co-fabricated micromachined trench structure;
an integrated photonic component comprising a second set of metal contact pads; and
an optical fiber;
wherein:
the second set of metal contact pads are connected to the first set of metal contact pads;
the co-fabricated micromachined trench structure comprises dimensions compatible with the optical fiber;
the optical fiber is bonded to, and disposed at least partially within, the micromachined trench structure; and
the optical fiber, the integrated photonic component, the co-fabricated spot size converter, and the silicon-on-insulator photonic circuit comprise optical modes that are spatially aligned with one another.

2. The integrated photonic module of claim 1, wherein the first set of metal contact pads and the second set of metal contact pads are connected with solder.

3. The integrated photonic module of claim 1, wherein:
the co-fabricated spot size converter transitions a spot size of the optical mode of the optical fiber into a submicron waveguide mode with negligible loss; and
the spot size of the optical mode of the optical fiber has a diameter from 3 microns to 12 microns.

4. The integrated photonic module of claim 1, wherein:
the integrated photonic component further comprises one or more waveguides; and
the waveguides are aligned with the co-fabricated spot size converter such that an optical mode of the integrated photonic component significantly aligns with an optical input of the co-fabricated spot size converter.

5. The integrated photonic module of claim 1, wherein the integrated photonic component comprises III-V materials.

6. The integrated photonic module of claim 1, wherein the co-fabricated micromachined structure comprises a V-groove geometry.

7. The integrated photonic module of claim 1, wherein the silicon-on-insulator photonic circuit further comprises control circuitry for the integrated photonic component.

8. The integrated photonic module of claim 1, wherein the co-fabricated spot size converter comprises a patterned waveguiding material with a lengthwise varied shape that allows for an adiabatic change in optical mode size.

9. The integrated photonic module of claim 8, wherein the patterned waveguiding material comprises a tapered geometry.

10. The integrated photonic module of claim 8, wherein the patterned waveguiding material comprises a photonic bandgap structure.

11. An integrated photonic module, comprising:
a silicon-on-insulator platform comprising:
a silicon-on-insulator photonic circuit;
a co-fabricated spot size converter; and
a co-fabricated micromachined trench structure; and
an optical fiber;
wherein:
co-fabricated micromachined trench structure comprises dimensions compatible with the optical fiber,
the optical fiber is bonded to, and disposed at least partially within, the micromachined trench structure, and
the optical fiber, the co-fabricated spot size converter, and the silicon-on-insulator photonic circuit comprise optical modes that are spatially aligned with one another.

12. The integrated photonic module of claim 11, wherein the co-fabricated spot size converter transitions optical mode of the fiber comprising from 3 micron to 12 micron diameters into a submicron waveguide mode with negligible loss.

13. The integrated photonic module of claim 11, wherein the co-fabricated micromachined structure comprises a V-groove geometry.

14. The integrated photonic module of claim 11, wherein the co-fabricated spot size converter comprises a patterned waveguiding material with a lengthwise varied shape that allows for an adiabatic change in optical mode size.

15. The integrated photonic module of claim 14, wherein the patterned waveguiding material comprises a tapered geometry.

16. The integrated photonic module of claim 14, wherein the patterned waveguiding material comprises a photonic bandgap structure.
